(19) United States
(12) Patent Application Publication
(10) Pub. No.: US 2025/0286567 A2
(43) Pub. Date: Sep. 11, 2025

(54) ANTENNE RECONFIGURABLE

(71) Applicant: Commissariat à l'Energie Atomique et aux Energies Alternatives, PARIS (FR)

(72) Inventors: Antonio CLEMENTE, GRENOBLE (FR); José Luis GONZALEZ JIMENEZ, GRENOBLE (FR)

(21) Appl. No.: 18/906,135

(22) Filed: Oct. 3, 2024

(30) Foreign Application Priority Data
Oct. 5, 2023 (FR) 2310684

(51) Int. Cl. H04B 1/00; H01Q 13/02; H01Q 21/29

(52) U.S. Cl. CPC H04B 1/0078; H01Q 13/02; H01Q 21/29

(57) ABSTRACT

The present description concerns an antenna comprising: an amplifier array comprising a plurality of first elementary cells; a transmitarray comprising a plurality of second elementary cells; and at least one source, wherein said at least one source is configured to irradiate, or to be irradiated by, the transmitarray, and the amplifier array is configured to irradiate and to be irradiated by the transmitarray.

### FIELD

The present disclosure generally concerns electronic devices, more particularly reconfigurable antennas.

### BACKGROUND

As compared with conventional antennas, reconfigurable antennas can have an improved gain and provide access to additional functionalities, for example of electronic beam steering or of multiple, pencil, or shaped beam emission. This benefits the development of many applications, such as radar systems, detection systems, and communication systems from the C-band (approximately from 4 to 8 GHz) to the D-band (approximately from 110 to 170 GHz). The use of reconfigurable antennas is further envisaged in a frequency band located around 300 GHz.

Multiple fields of application are likely to take advantage of reconfigurable antennas, among which:
motor vehicle driver assistance radars, for example, for active security purposes;
very-high-resolution imaging and monitoring systems;
very-high-speed millimeter-wave communication systems, for example for inter-or intra-building communications in a home or building automation environment;
antennas for space applications, for example Ka-band LEO (Low Earth Orbit) ground-to-satellite telemetry links, reflector antennas dedicated to satellite communications with a reconfigurable primary source, SOTM (Satellite On The Move) systems, Internet access devices or systems, television broadcasting devices or systems, etc.; and
point-to-point and point-to-multipoint communication systems, such as metropolitan area networks, fronthaul and backhaul systems for cellular networks, radio accesses for 5G mobile networks, etc.

Among existing high-gain antennas, reflector antennas have in particular been provided. These antennas are however complex and expensive to build since reflectors require, in particular for high-frequency applications, a very precise curvature. Further, motors are used to steer the beam in the desired direction. Phased-array antennas have been provided to allow an electronic control of the beam. However, these antennas turn out being expensive to be developed and produced, in particular due to the fact that they comprise amplification modules aiming at compensating for losses induced by phase-shift circuits.

Other reconfigurable beam steering and/or beam-forming antennas have further been provided. Among these antennas, there in particular exist transmitarray antennas, also known as discrete lens antennas. Existing transmitarray antennas generally comprise a radiating panel comprising reconfigurable elementary cells, or transmitter cells. Each elementary cell of the radiating panel comprises a first antenna element irradiated by an electromagnetic field emitted by one or a plurality of focal sources, a second antenna element transmitting a modified signal to the outside of the antenna, and a coupling element between the first and second antenna elements. The elementary cells are intended to control an electromagnetic field distribution in the vicinity of a radiating aperture of the antenna, thus enabling to produce one or a plurality of beams in a given direction or to synthesize a beam with a defined template. In an ideal case, each elementary cell is capable of compensating for any path difference between the focal source(s) and the radiating aperture. In practice, for the sake of simplification of the antenna, the elementary cells can only compensate for a limited number of phase states, for example 2N phase states, with N a positive integer, in the case of a compensation with an N-bit phase quantization. A same transmitarray can alternate between transmit and receive phases, provided for it to be free of non-reciprocal elements such as amplifiers or attenuators. Otherwise, the transmitarray can only operate in transmit or in receive mode.

Transmitarray antennas, however, suffer from various disadvantages. In particular, existing transmitarray antennas have a relatively large thickness, dictated by the need to keep the focal source(s) away from the transmitting array.

### SUMMARY

It would be desirable to overcome all or part of the disadvantages of existing reconfigurable antennas. There more particularly exists a need for reconfigurable antennas having an improved performance, a decreased power consumption, and a smaller bulk than existing reconfigurable antennas, for example to meet the needs of applications such as satellite communications (SATCOM).

For this purpose, an embodiment provides an antenna comprising:
an amplifier array comprising a plurality of first elementary cells;
I a transmitarray comprising a plurality of second elementary cells; and
at least one source,
   wherein said at least one source is configured to irradiate, or to be irradiated by, the transmitarray, and the amplifier array is configured to irradiate and to be irradiated by the transmitarray.

According to an embodiment, each first elementary cell comprises at least one first antenna element located in front of the transmitarray.

According to an embodiment, each first elementary cell further comprises at least one amplifier connected to said at least one first antenna element.

According to an embodiment, each first elementary cell comprises:
a first amplifier, preferably a power amplifier, intended to amplify a signal transmitted by the antenna;
a second amplifier, preferably a low-noise amplifier, intended to amplify a signal received by the antenna; and
switches configured to enable the first or the second amplifier according to a control signal.

According to an embodiment, each second elementary cell comprises a second antenna element intended to reflect, towards the amplifier array, a signal originating from said at least one source and/or to reflect, towards said at least one source, a signal originating from the amplifier array.

According to an embodiment, the second antenna elements are located in front of the amplifier array and of said at least one source.

According to an embodiment, each second elementary cell comprises a third antenna element coupled to the second antenna element by a phase-shift circuit.

According to an embodiment, each first cell is adapted to performing a polarization rotation.

According to an embodiment, said at least one source is a single horn antenna.

According to an embodiment, the antenna comprises fewer first elementary cells than second elementary cells, preferably four times fewer first elementary cells than second elementary cells.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a simplified and partial side view of an example of a transmitarray antenna;

FIG. 2 is a simplified and partial side view of a reconfigurable antenna according to an embodiment; and

FIG. 3 is a detail view of a portion of the antenna of FIG. 2.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the methods of manufacturing the described transmitarrays will not be detailed, the forming of the described structures being within the abilities of those skilled in the art based on the indications of the present disclosure, for example by implementing conventional printed circuit board manufacturing techniques.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

In the following description, the qualifiers “insulating” and “conductive” respectively mean, unless specified otherwise, electrically insulating and electrically conductive.

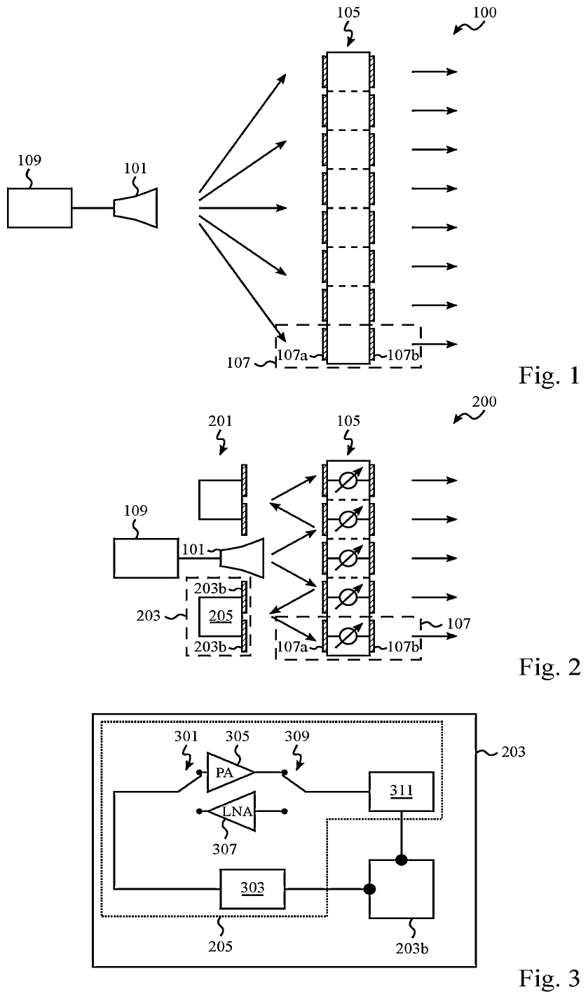

FIG. 1 is a simplified and partial side view of an example of a transmitarray antenna 100.

Antenna 100 typically comprises one or a plurality of primary sources 101 (a single source 101, in the shown example) irradiating a transmitarray 105. Source 101 may have any polarization, for example linear or circular. Array 105 comprises a plurality of elementary cells 107, for example arranged in an array of rows and columns. Each cell 107 typically comprises a first antenna element 107a, located on the side of a first surface of array 105 arranged in front of primary source 101, and a second antenna element 107b, located on the side of a second surface of the array opposite to the first surface. The second surface of array 105 for example faces a transmitting medium, or external medium, of antenna 100.

Each cell 107 is capable, in transmit mode, of receiving an electromagnetic radiation on its first antenna element 107a and of transmitting back this radiation from its second antenna element 107b, for example by introducing a known phase shift ϕ. In receive mode, each cell 107 is capable of receiving an electromagnetic radiation on its second antenna element 107b and of transmitting back this radiation from its first antenna element 107a, towards source 101, with the same phase shift ϕ. The radiation transmitted back by the first antenna element 107a is, for example, focused onto source 101.

The characteristics of the near-or far-field radiation generated by antenna 100, in particular its shape (or template), its intensity, and its maximum emission direction (or pointing direction), depend on the values of the phase shifts respectively introduced by the different cells 107 of array 105.

Transmitarray antennas have as advantages, among others, of having a good power efficiency and of being relatively simple, inexpensive, and of low bulk. This is particularly due to the fact that transmitarrays can be built in planar technology, generally on a printed circuit board.

The present disclosure more particularly targets reconfigurable fixed-beam transmitarray antennas 105. Transmitarray 105 is said to be reconfigurable when the elementary cells 107 are individually electronically controllable to modify their phase shift value o and/or their amplitude, which enables to dynamically modify the characteristics of the radiation generated by the antenna, and in particular to modify its pointing direction without mechanically moving the antenna or a portion of the antenna by means of a motorized element.

In the shown example, primary source 101 is connected to a circuit 109. Circuit 109 is, for example, a transmit and/or receive circuit respectively intended to generate signals to be transmitted by reconfigurable antenna 100 and/or to process signals received by reconfigurable antenna 100. This example is however not limiting, and circuit 109 may further implement additional functions such as functions of analog-to-digital conversion, filtering, impedance matching, interference elimination, etc.

FIG. 2 is a simplified and partial side view of a reconfigurable antenna 200 according to an embodiment. The antenna 200 of FIG. 2 comprises elements in common with the antenna 100 of FIG. 1. These common elements will not be detailed again hereafter.

The reconfigurable antenna 200 of FIG. 2 differs from the reconfigurable antenna 100 of FIG. 1 in that reconfigurable antenna 200 further comprises an amplifier array 201 comprising a plurality of elementary cells 203. Amplifier array 201 is preferably positioned in a field region close to transmitarray 105.

According to an embodiment, source 101 is configured to irradiate, or to be irradiated by, transmitarray 105, and amplifier array 201 is configured to irradiate and to be irradiated by transmitarray 105.

The elementary cells 203 of amplifier array 201 are for example arranged in an array of rows and columns. Further, elementary cells 203 are for example substantially located in a same plane, array 201 being in this case of planar type. Each elementary cell 203 comprises at least one antenna element 203b (two antenna elements 203b, in the shown example) located on the side of a surface of amplifier array 201 facing transmitarray 105. Each elementary cell 203 further comprises an amplification circuit 205 (symbolized in FIG. 2 by a square) connected to the antenna element(s) 203b of the cell. As an example, amplifier array 201 is built in planar technology, for example on a printed circuit board.

The amplifier array 201 of reconfigurable antenna 200 for example comprises a number of antenna elements 203b equal to the number of first antenna elements 107a of transmitarray 105, each antenna element 203b of amplifier array 201 being for example located in front of one of the first antenna elements 107a of transmitarray 105. However, this example is not limiting and amplifier array 201 may, as a variant, comprise a number of antenna elements 203b smaller than or greater than the number of first antenna elements 107a of transmitarray 105.

The elementary cells 107 of transmitarray 105 are for example substantially located in a same plane, for example a plane substantially parallel to the plane of amplifier array 201. Each elementary cell 107 of transmitarray 105 is for example separated from the adjacent elementary cells 107 by a distance equal to approximately half a central transmission and/or reception wavelength of antenna 200.

In the shown example, reconfigurable antenna 200 comprises a number of elementary cells 203 smaller than the number of elementary cells 107. This example is however not limiting, and reconfigurable antenna 200 may, as a variant, comprise a number of elementary cells 203 equal to or greater than the number of elementary cells 107. As an example, reconfigurable antenna 200 comprises four, nine, or sixteen times fewer amplification circuits 205 than elementary cells 107, each elementary cell 203 then for example comprising respectively four, nine, or sixteen antenna elements 203b.

Although only two elementary cells 203 and five elementary cells 107 have been shown in FIG. 2, reconfigurable antenna 200 may of course comprise numbers of elementary cells 203 and of elementary cells 107 different from those shown, for example several tens, several hundreds, or several thousands of elementary cells 203 and of elementary cells 105.

FIG. 2 more particularly illustrates a case in which reconfigurable antenna 200 operates in transmit mode. In this case, source 101 irradiates transmitarray 105, each cell 107 of which is capable of receiving an electromagnetic radiation originating from source 101 on its first antenna element 107a, and of transmitting back this radiation from its first antenna element 107a towards amplifier array 201. In transmit mode, the first antenna element 107a enables to reflect the electromagnetic radiation originating from source 101 towards the elementary cells 203 of amplifier array 201. The first antenna elements 107a of elementary cells 107 for example have, for this purpose, a polarization substantially orthogonal to the polarization of source 101. As an example, the second antenna elements 107b of elementary cells 107 have a linear polarization parallel or orthogonal to the polarization of the first elementary cells 107a. As a variant, the second antenna elements 107b of elementary cells 107 have a circular polarization.

In transmit mode, each elementary cell 203 of amplifier array 201 is capable of receiving, on its antenna element 203b or one of its antenna elements 203b, an electromagnetic radiation originating from the reflection, on the first antenna elements 107a of the elementary cells 107 of transmitarray 105, and to transmit, from its antenna element 203b or another of its antenna elements 203b, an amplified electromagnetic radiation of modified polarization towards transmitarray 105. Elementary cells 203 are for example adapted to performing a polarization rotation, for example in the order of 90°, between the received radiation and the transmitted back radiation. In this case, the electromagnetic radiation transmitted back by the elementary cells 203 of amplifier array 201 has, for example, a polarization substantially parallel to that of the first antenna elements 107a of the elementary cells 107 of transmitarray 105. Each cell 107 is capable, in transmit mode, of receiving, on its first antenna element 107a, an electromagnetic radiation originating from amplifier array 201 and of transmitting back this radiation, from its second antenna element 107b, for example by introducing a known phase shift ϕ.

The characteristics of the near-field or far-field radiation generated by antenna 200, in particular its shape (or template), its intensity and its maximum emission direction (or pointing direction), depend on the values of the phase shifts respectively introduced by the different elementary cells 107 of transmitarray 105.

Although this has not been shown, reconfigurable antenna 200 may, as a variant, operate in receive mode. In this case, each elementary cell 107 of transmitarray 105 is capable of receiving, on its second antenna element 107b, an electromagnetic radiation originating from the external environment and of transmitting back this radiation, from its first antenna element 107a, towards the elementary cells 203 of amplifier array 201, with phase shift ϕ. In receive mode, each elementary cell 203 of amplifier array 201 is capable of receiving, on its antenna element 203b or one of its antenna elements 203b, an electromagnetic radiation originating from transmitarray 105 and of transmitting, from its antenna element 203b or another of its antenna elements 203b, an amplified electromagnetic radiation of modified polarization towards transmitarray 105. The electromagnetic radiation transmitted back by the elementary cells 203 of amplifier array 201, for example, has a polarization substantially orthogonal to that of the first antenna elements 107a of the elementary cells 107 of transmitarray 105. In this case, each cell 107 is capable of receiving an electromagnetic radiation originating from amplifier array 201 on its first antenna element 107a, and of transmitting back this radiation from its first antenna element 107a. In receive mode, the first antenna element 107a for example enables to reflect the electromagnetic radiation originating from amplifier array 201 towards source 101.

Each elementary cell 107 for example comprises a phase-shift circuit having a first terminal connected to the first antenna element 107a, located in front of source 101 and towards amplifier array 201, and having a second terminal connected to the second antenna element 107b, facing the external environment. The phase-shift circuit is for example configured to apply a phase shift ϕ between the signal received by antenna element 107a and the signal transmitted by antenna element 107b, in the case where reconfigurable antenna 200 operates in transmit mode, or to apply phase shift ϕ between the signal received by antenna element 107b and the signal transmitted by antenna element 107a, in the case where reconfigurable antenna 200 operates in receive mode.

FIG. 2 illustrates an example in which each elementary cell 107 is configured to introduce a phase shift o between the signals received or transmitted by antenna element 107a and the signals transmitted or received by antenna element 107b. This example is however not limiting, and the elementary cell may, as a variant or as a complement, implement other functions, for example a polarization state change function enabling to pass from a signal having a left-hand circular polarization to a signal having a right-hand circular polarization. As an example, each elementary cell 107 of reconfigurable transmitarray 105 has a structure identical or similar to the elementary transmitarray cell described in patent application EP 4117117, the cell then being adapted, for example, to switching between two polarization states and four phase states.

FIG. 3 is a detail view of a portion of the reconfigurable antenna 200 of FIG. 2. FIG. 3 more precisely is an equivalent electrical diagram of one of the elementary cells 203 of amplifier array 201.

In the shown example, elementary cell 203 comprises a switch 301, for example a single-pole double-throw (SPDT) switch. In this example, switch 301 more precisely comprises an input connected to a circuit 303, a first output connected to an input of a first amplifier 305 (PA), and a second output connected to an output of a second amplifier 307 (LNA). Switch 301 for example receives a control signal to connect its input to its first output, when reconfigurable antenna 200 is used in transmit mode, and to its second output, when reconfigurable antenna 200 is used in receive mode.

The amplifier 305 of elementary cell 203 is for example intended to amplify a signal transmitted by antenna 200. As an example, amplifier 305 is a power amplifier, for example a class-A linear amplifier in CMOS (Complementary Metal-Oxide-Semiconductor) SOI (Silicon On Insulator) technology, for example of the type described in the article by A. Hamani, A. Siligaris, B. Blampey, and J. L. G. Jimenez entitled “167-GHz and 155-GHz High Gain D-band Power Amplifiers in CMOS SOI 45-nm” from the fifteenth “European Microwave Integrated Circuits Conference (EuMIC)” in Utrecht, the Netherlands, 2021, pages 261-264.

The amplifier 307 of elementary cell 203 is for example intended to amplify a signal received by antenna 200. As an example, amplifier 307 is a low-noise amplifier (LNA). This enables to optimize the noise figure of elementary cell 203 when it is used in receive mode. As an example, amplifier 307 comprises a class-“AB” amplifier comprising, for example, one or two operating stages. Amplifier 307 for example has an electrical power in the range from 10 to 20 mW.

In the shown example, elementary cell 203 comprises another switch 309, for example a single-pole double-throw (SPDT) switch. In this example, switch 309 more precisely comprises an input connected to a circuit 311, a first output connected to an output of the first amplifier 305, and a second output connected to an input of the second amplifier 307. Switch 309 for example receives a control signal to connect its input to its first output, when reconfigurable antenna 200 is used in transmit mode, and to its second output, when reconfigurable antenna 200 is used in receive mode.

As an example, circuits 303 and 311 are circuits of impedance matching and/or decoupling between radio frequency signals and low-frequency signals, for example DC signals.

In the shown example, circuits 303 and 311 each comprise a terminal connected to antenna element 203b. Circuits 303 and 311 are, for example, connected to different regions of antenna element 203b. As an example, antenna element 203b is a patch antenna comprising, for example, a conductive plane of rectangular or square shape having a U-shaped slot formed therein.

FIG. 3 illustrates an example in which elementary cell 203 comprises switches 301 and 309 enabling to activate either amplifier 305, during transmit phases, or amplifier 307, during receive phases. This example is however not limiting, and each elementary cell 203 of array 201 may, as a variant, be devoid of switches 301 and 309 and comprise a single amplifier, for example amplifier 305 in a case where antenna 200 is used exclusively in transmit mode, or amplifier 307, in a case where antenna 200 is used exclusively in receive mode.

An advantage of reconfigurable antenna 200 lies in the fact that the presence of amplifier array 201 advantageously enables to bring primary source 101 closer to transmitarray 105. In other words, this enables to “fold” the source of antenna 200 with respect to the case of antenna 100. Antenna 200 thus has a thickness smaller, for example in the order of three times smaller, than that which would be exhibited by a comparable transmitarray antenna, for example antenna 100. This further provides the advantage, as compared with a transmitarray antenna of the type of antenna 100, of facilitating the building of systems for amplifying the transmitted or received radio frequency signal.

Although this has not been detailed hereabove in relation with FIGS. 2 and 3, source 101 may be connected to an amplification circuit, for example integrated in circuit 109, the amplification circuit then for example comprising an amplifier similar or identical to amplifier 305, for a use of antenna 200 in transmit mode, and/or an amplifier similar or identical to amplifier 307, for a use of antenna 200 in receive mode. In a case where antenna 200 is intended to be able to alternately operate in transmit or in receive mode, one or a plurality of switches similar or identical to switches 301 and 309 may then be provided to activate one or the other amplifier of the amplification circuit.

Various embodiments and variants have been described. Those skilled in the art will understand that certain features of these various embodiments and variants may be combined, and other variants will occur to those skilled in the art. In particular, those skilled in the art are capable of adjusting the ratio of the number of elementary cells 203 of amplifier array 201 to the number of elementary cells 107 of transmitarray 105 according to the application, for example according to the heating generated by each elementary cell 203.

Further, although this has not been detailed hereabove, the elementary cells 203 of amplifier array 201 may, in addition to the amplification functions, implement other functions, for example phase-shift functions. In this case, the phase-shift functions for example use varactor or switch structures.

Finally, the practical implementation of the described embodiments and variants is within the abilities of those skilled in the art based on the functional indications given hereabove. In particular, the practical implementation of the antenna element(s), of the switch(es), and of the amplifier(s) of the elementary cells of amplifier array 201, as well as the practical implementation of the elementary cells of transmitarray 105 are within the abilities of those skilled in the art based the indications of the present disclosure. Those skilled in the art are further capable of adjusting the number of antenna elements 203b of each elementary cell 203 of amplifier array 201, in particular according to the proportion of elementary cells 203 of amplifier array 201 with respect to the elementary cells 107 of transmitarray 105.

Further, the elementary cells 107 of transmitarray 105 may be calibrated to correct phase errors linked to the structure of the antenna.

What is claimed is:

1. Antenna comprising:
an amplifier array comprising a plurality of first elementary cells;
a transmitarray comprising a plurality of second elementary cells; and
at least one source,
wherein said at least one source is configured to irradiate, or to be irradiated by, the transmitarray, and the amplifier array is configured to irradiate and to be irradiated by the transmitarray.

2. Antenna according to claim 1, wherein each first elementary cell comprises at least one first antenna element located in front of the transmitarray.

3. Antenna according to claim 2, wherein each first elementary cell further comprises at least one amplifier connected to said at least one first antenna element.

4. Antenna according to claim 3, wherein each first elementary cell comprises:
a first amplifier, preferably a power amplifier, intended to amplify a signal transmitted by the antenna;
a second amplifier, preferably a low-noise amplifier, intended to amplify a signal received by the antenna; and
switches configured to enable the first or the second amplifier according to a control signal.

5. Antenna according to claim 1, wherein each second elementary cell comprises a second antenna element intended to reflect, towards the amplifier array, a signal originating from said at least one source and/or to reflect, towards said at least one source, a signal originating from the amplifier array.

6. Antenna according to claim 5, wherein the second antenna elements are located in front of the amplifier array and of said at least one source.

7. Antenna according to claim 5, wherein each second elementary cell comprises a third antenna element coupled to the second antenna element by a phase-shift circuit.

8. Antenna according to claim 1, wherein each first cell is adapted to performing a polarization rotation.

9. Antenna according to claim 1, wherein said at least one source is a single horn antenna.

10. Antenna according to claim 1, comprising fewer first elementary cells than second elementary cells, preferably four times fewer first elementary cells than second elementary cells.
